(19) United States
(12) Patent Application Publication
(10) Pub. No.: US 2005/0076824 A1
(43) Pub. Date: Apr. 14, 2005

(54) Resistive touch screen incorporating conductive polymer

(76) Inventors: Elisa M. Cross, Woodbury, MN (US); Robert S. Moshrefzadeh, Oakdale, MN (US); Bernard O. Geaghan, Salem, NH (US)

Correspondence Address: 3M INNOVATIVE PROPERTIES COMPANY, PO BOX 33427, ST. PAUL, MN, 55133-3427, US

(21) Appl. No.: 10/681,434

(22) Filed: Oct. 8, 2003

(51) Int. Cl. B05D 5/12; G01D 11/00

(52) U.S. Cl. 116/205; 427/101; 116/200

(57) ABSTRACT

Conductive polymers can be used as the signal carrying layers in resistive touch screens. Using conductive polymers can allow higher sheet resistance than is conventionally obtained using indium tin oxide while maintaining electrical continuity and durability of the layer. Higher sheet resistance can also lead to reduced errors and reduced power consumption, as well as better optical transmission. Sheet resistance may be limited on an upper end by desired data sampling rates. Also disclosed are resistive touch screens that employ a conductive polymer on both the topsheet and bottom substrate and that can be operated with the use of conventional electronics.

### FIELD OF THE INVENTION

The present invention relates generally to touch sensors, particularly touch sensors that are used in conjunction with a display device to form a touch screen.

### BACKGROUND OF THE INVENTION

Typical resistive touch screens include two clear conductive layers separated by spacers, the transparent conductive layers being formed of a transparent conductive oxide (TCO), commonly indium tin oxide (ITO), and sometimes tin antinomy oxide (TAO), tin oxide (TO) or zinc oxide (ZnO). Conventionally, resistive touch screens include opposing ITO layers with a surface resistivity, or sheet resistance, of about 250 to 600 ohms/square. ITO layers, and other TCOs, are generally vacuum deposited. Making an ITO layer with higher surface resistivity requires depositing a very thin layer. As the layer of ITO becomes thinner, problems with resistance uniformity, discontinuity of the film and durability of the film may arise. As a result, touch screen manufacturers typically use thicker, relatively low resistance ITO layers for uniformity, durability and reliability reasons.

Other TCOs, such as TAO and ZnO, have somewhat higher sheet resistance than ITO. However, these oxides are more expensive and are not as optically efficient for the same sheet resistance as ITO. For example, TAO has lower transmission than ITO for the same sheet resistance. In addition, TAO and ZnO are not as widely available on sheets of polyethylene terephthalate (PET), which are frequently used as the flexible topsheet in resistive touch screen constructions.

Electronic displays such as LCDs also use layers of ITO but typically include layers with a sheet resistance of 10 to 100 ohms/square. The same companies that make layers of ITO for LCDs often manufacture the layers of ITO used in touch screens. However, these companies have developed their process capability primarily for the LCD devices, so that they use lower resistance ITO layers than are optimal for touch screens.

An ITO film with a sheet resistance of 20 ohms/square is about 500 nm thick. An ITO film having a sheet resistance of 350 to 400 ohms/square is only about 30 to 35 nm thick. Uniformity, durability, and physical continuity of a deposited ITO are generally degraded as the film is coated thinner. For example, ITO is generally not coated at a resistivity range of about 1,000 to 2,000 ohms/square because it has to be so thin that it may not be durable, uniform or physically continuous.

Further investigation is needed into optimal sheet resistance for conductive layers of resistive touch screens. Improved conducting layers having optical and conductive properties within an optimal range are needed.

### SUMMARY OF THE INVENTION

The present invention provides a resistive touch screen that includes a top sheet movable toward a bottom substrate under the influence of a touch input, the top sheet including a first conductive polymer layer facing a second conductive polymer layer disposed on the bottom substrate, the touch screen configured for electronic coupling to controller electronics that use signals generated when the first and second conductive polymer layers make local contact to determine the position of local contact.

In another aspect the present invention provides a resistive touch screen in which at least one of the two facing resistive layers is a conductive polymer layer. Controller electronics are electronically coupled to the resistive layers, the controller electronics being configured to use signals generated when the first and second resistive layers make local contact under a touch to determine the position of the touch. The touch screen yields 100,000 or more touch inputs in the same location before failure of the device when the controller electronics are operated at about 3 to 5 volts.

In yet another aspect the present invention provides a method of making a resistive touch sensor, including selecting a desired minimum sampling rate for the touch sensor, selecting a touch sensor construction and dimensions for the resistive layer, determining the RC constant of the resistive layer given the selected dimensions, determining a maximum sheet resistance for the resistive layer based on the determined RC constant, and coating a conductive polymer material on the substrate to form the resistive layer at a thickness that gives a sheet resistance that does not exceed the maximum sheet resistance.

Other features and advantages of the invention will be apparent from the following detailed description of the invention and the claims. The above summary of principles of the disclosure is not intended to describe each illustrated embodiment or every implementation of the present disclosure.

### BRIEF DESCRIPTION OF THE DRAWINGS

The invention may be more completely understood in consideration of the following detailed description of various embodiments of the invention in connection with the accompanying drawings, in which:

FIG. 1 is an exploded schematic view of a 4-wire resistive touch screen;

FIG. 2 is a schematic view of a topsheet of a 4-wire resistive touch screen;

FIG. 3 is a schematic circuit view of a resistive touch screen;

FIG. 4 is a schematic view of a substrate of a 4-wire resistive touch screen;

FIG. 5 is a chart depicting the relative error with increasing sheet resistance for 5-wire resistive touch screens having resistive layers with different starting sheet resistances;

FIG. 6 is a chart depicting maximum sampling rate versus sheet resistance for touch screen having various sizes; and

FIG. 7 is a chart depicting internal transmission for conductive polymer resistive layers as a function of the sheet resistance of the resistive layers.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present invention is applicable to a number of touch screens using resistive or capacitive technology and incorporating a conductive layer. While the present invention is not so limited, an appreciation of various aspects of the invention will be gained through a discussion of the examples provided below.

Both capacitive and resistive touch screens include a resistance or impedance element, such as an area of resistive material, having terminals at the ends or boundaries. Conventionally, the resistance element is made of a transparent conductive oxide (TCO). ITO, with a sheet resistance of approximately 100 to 600 ohms/square is typically used on resistive touch screens, and TAO, with a sheet resistance of approximately 1000 to 3000 ohms/square is often used on capacitive touch screens. The present invention demonstrates that sheet resistance can be optimized by using higher sheet resistance, resulting in touch sensors having reduced errors, lower power consumption, and better optics while achieving a desirable response rate. In one embodiment, the present invention provides a resistive touch screen where the resistance elements have a sheet resistance in an optimum range, which may be determined by an examination of the desired optical properties and response times of the touch sensor. This optimum resistance may be achieved by the use of a conductive polymer, as discussed in further detail herein.

Higher sheet resistance can provide several advantages in a touch screen. For example, high sheet resistance can lead to lower power consumption, a reduction in errors from various sources, and higher light transmission through the touch screen device. Each of these advantages is discussed in further detail herein.

To date, the advantages of using higher sheet resistances in touch screens have not been fully explored. When using a TCO as the resistance element of a touch screen, the range of attainable sheet resistances is relatively limited due to difficulties in forming very thin, and therefore higher resistivity, TCO layers. As such, performance improvements could not have been expected when attempting to achieve sheet resistance levels using a TCO layer that required forming the TCO layer much thinner than could practically be made within a desirable range of thickness uniformity and durability. The present inventors have discovered that by using conductive polymers to form the resistance elements of touch screens, higher sheet resistances can be more readily obtained.

Conductive polymers can be coated at thicknesses that allow reasonable uniformity while yet obtaining sheet resistivity higher than that conventionally used in touch screens. In addition, the sheet resistance of conductive polymer layers can be further tuned by choosing a suitable conductive polymer that exhibits relatively high sheet resistance when coated as a film or layer, by reducing the thickness of the conductive polymer layer, by reformulating the conductive polymer materials (e.g., by adding inert binder material), by otherwise changing the electronic properties of the conductive polymer material before or after forming the layer (e.g., by using a chemical or radiation treatment), or by any suitable combination of these. Often, higher sheet resistance conductive polymer layers can be accomplished using cost effective coating processes while maintaining or enhancing desired properties.

Higher sheet resistance elements can also provide benefits relating to linearization of touch screens. Resistive and capacitive touch screens are operated by applying an electric field across the resistive layer. Capacitive and 5-wire sensors have conductive elements distributed around the border of the resistive layer to help distribute the electric field. The more uniformly the electric field is distributed, the more accurate the touch screen. This is known as linearization. The conductive elements of the linearization pattern are more conductive, and preferably much more conductive, than the resistance element. As such, providing resistance elements having higher sheet resistance allows for a wider variety of linearization patterns and materials, which may allow for easier manufacturing. In addition, higher sheet resistance may allow the use of narrower linearization patterns.

As mentioned, using resistance elements having higher sheet resistance can have several benefits, including increased accuracy, improved optics, and greater ease in linearizing the electric field applied to the resistance element. At some point, however, increasing sheet resistance will lead to a noticeable increase in response times. This marks an upper boundary on a desirable range of sheet resistance, which boundary may depend on the type of touch screen used, the size of the touch screen, and the particular application in which the touch screen is used. Issues related to determining the upper boundary of sheet resistance have not to date been explored in the art. Optimum sheet resistance may be considered as any sheet resistance high enough to realize the advantages of increased sheet resistance, yet below an upper boundary above which response times become too long.

In addition to the benefits of being able to use higher sheet resistances, conductive polymers as resistance elements in touch screens in place of TCO layers can provide improved optics, even at the same sheet resistances conventionally used with TCOs. Conductive polymers generally have a lower refractive index than TCOs, which can lead to better light transmission through the touch screen as well as a higher contrast ratio due to decreased interfacial reflections. The use of TCOs often leads to a yellowish display appearance, which can be improved using conductive polymers having a higher transmission in the blue portion of the visible spectrum. The use of conductive polymers can also provide enhanced durability over the use of TCOs, which can be quite brittle and prone to cracking and flaking during manufacture, handling, and use.

Some benefits of the present invention can be illustrated with regard to the use of conductive polymers in resistive touch screens. Resistive touch screens include a bottom resistive layer disposed on a bottom substrate, which is generally rigid, and a top resistive layer disposed on a top substrate, which is sufficiently flexible to bend under the influence of a touch input so that the top resistive layer can make local contact with the bottom resistive layer at the location of the touch input.

In 4-wire resistive touch screens, the bottom resistive layer includes electrodes on two opposing edges so that an electric field can be applied across the layer. The top resistive layer includes electrodes on the other two opposing edges so that an electric field can be applied across the layer in a direction orthogonal to that of the bottom layer. When contact is made between the resistive layers, the signal generated on the bottom layer is used to determine the touch location along one axis (e.g., the x-axis), and the signal generated on the top layer is used to determine the touch location along the orthogonal axis (e.g., the y-axis). Because the top layer is flexed under touch inputs, the top resistance layer has a tendency to crack or flake when it is composed of a brittle material such as a TCO. This can cause a loss of accuracy and functionality over time. As such, the industry has developed 5-wire resistive constructions where the top layer is merely a voltage sensing layer rather than a signal generating layer, and both touch coordinates are determined by signals generated on the bottom layer. 5-wire constructions are generally more complex, and thus can be more difficult and costly to make. Using conductive polymers as the resistive layer elements allows 4-wire touch screens to be made and used without the same concern for loss of accuracy and functionality over time due to cracking of the top resistive layer.

In 5-wire resistive touch screens, the bottom, signal-carrying, resistive layer is often disposed on a rigid substrate. Even so, it can be beneficial to use a conductive polymer as the bottom resistive layer, whether or not a conductive polymer is used as the resistive layer of the flexible top sheet. Conductive polymers can provide higher transmission over TCO layers having the same sheet resistance. Conductive polymers can allow the use of a higher sheet resistance layer, thus providing benefits of a uniform, high sheet resistance layer in a touch screen, which can include lower power consumption, reduced errors, higher transmission, and easier linearization and/or narrower border lineraization patterns.

Although conductive polymers have been disclosed in the art for use in touch screens, they have been described particularly for adding durability, without discussing optimizing sheet resistance. For example, conductive polymers can be used as the conductive layer of the flexible top sheet of a 5-wire resistive touch screen to improve mechanical properties over those exhibited by the use of ITO, as described in U.S. Pat. No. 6,469,267. However, to maintain such advantages over time, the excitation of the electric circuit of such a touch screen was carefully controlled. This included keeping the conductive polymer layer at a negative bias relative to the conventional TCO conductive layer disposed on the bottom substrate. Such biasing may not be compatible with conventionally available controller electronics, requiring the design of specialized electronics.

In the present invention, conductive polymers can be used as the signal carrying layers on each substrate of a resistive touch screen and are compatible with conventional controller electronics. When conducting polymer is used as both conductive layers, restrictions on the voltage and bias of the device are unnecessary. This may avoid the need for design restrictions on electronics development, and can allow the manufacture of new technology touch screens that are backward compatible with existing controllers.

Conductive polymers have also been described for use as a supplemental coating disposed on conventional TCO conductive layers in capacitive touch screens that employ a flexible substrate. In such a case, the conductive polymer may help maintain performance of the device if the relatively brittle TCO layer cracks due to flexing of the device during manufacture, handling, or use. In such a case, the electronic properties of the TCO layer is still relied upon for carrying touch signals, and therefore has the same limitations with respect to sheet resistance attainability.

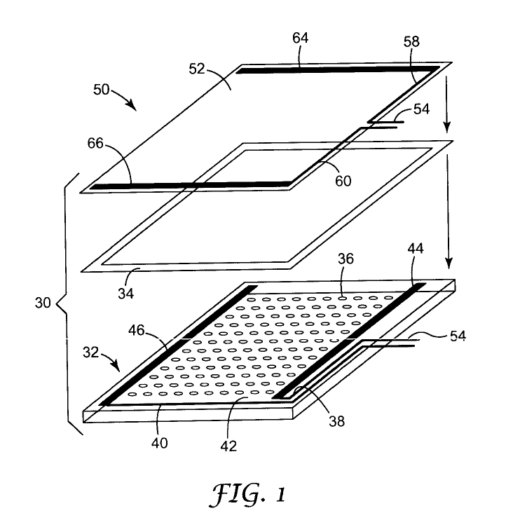

4-wire resistive touch sensors are common, and can be used to discuss various aspects of the present invention. As such, FIGS. 1 through 4 show 4-wire resistive touch sensors, in which common reference numerals refer to the same or similar elements. Sources of possible error in this type of construction will be also explained, along with new techniques for minimizing these errors. However, it will be appreciated to one of ordinary skill that the various concepts described can be applied to any other resistive touch sensor construction, such as 5-wire, 8-wire, and 7-wire constructions.

Resistive touch sensors are constructed like a sandwich, where the touch is registered by the compression of a top flexible layer against an underlying substrate layer of treated plastic or glass. Both layers are coated with a resistive material on the inside of the sandwich, and spacer dots are usually placed between the top sheet and substrate layer. When touched by a finger or stylus, the top sheet deforms, making contact with the bottom layer, or substrate. A voltage gradient is applied across the substrate, with the top sheet acting as a voltage probe to determine one coordinate of the touch position from the voltage signal. In a 4-wire construction, the substrate is then used as a probe to determine the other position coordinate from a voltage gradient on the top sheet in the orthogonal direction. Other resistive technologies, such as 5-wire, utilize the flexible top sheet as a voltage sensing layer, and both touch position coordinates are obtained using signals generated on the bottom substrate's conductive layer.

Four additional sensing wires are sometimes added to 4-wire resistive sensors to reduce errors caused by changes in sensor resistances. Known as the 8-wire type of resistive touch screen, this implementation enables compensation for errors caused by changes in voltage across cables and interconnects due to temperature changes, humidity, or ageing. Two additional connections are made through the cable to each of the two electrodes, thus doubling the number of “wires” from four to eight. Likewise, the 7-wire resistive touch sensor is a variant on the 5-wire resistive design in that it adds two additional wires, each running to opposite corners of the substrate, to monitor the voltage. These two additional reference lines provide feedback to the controller that can cancel out changes in voltage caused by environmental or physical changes, such as aging or temperature fluctuations. As such, 8-wire and 7-wire sensors are analogues of 4-wire and 5-wire sensors, respectively, that provide additional feedback that can be used to compensate for changes in sheet resistance. This may be particularly suited to sensors that utilize a resistive layer material that may be susceptible to changing environments. For example, some conductive polymers may exhibit changes in sheet resistance with age, high temperatures, or high humidity.

FIG. 1 is an exploded view of a 4-wire resistive touch sensor 30, including a bottom substrate 32 and a top sheet 50, separated by an insulating spacer layer 34 present in the border area. The bottom substrate 32 includes clear spacer dots 36 to maintain the normal separation between a resistive surface 42 of the bottom substrate 32 and a resistive surface 52 of the top sheet 50.

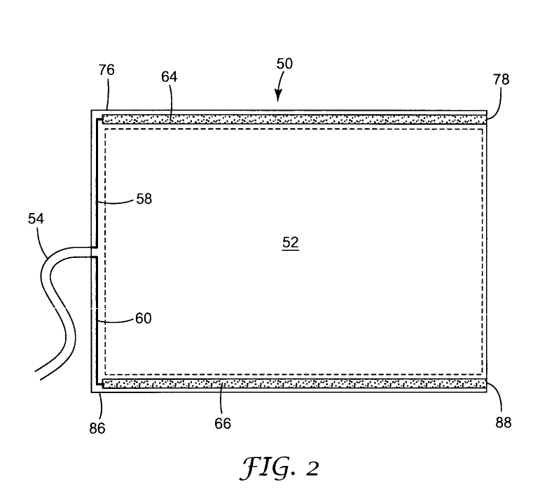

FIG. 2 is a diagram of a top sheet 50 of a 4-wire resistive touch sensor. The top sheet 50 generates a vertical voltage gradient and measures vertical position of a touch on the touch sensor. The bottom substrate 32 (seen in FIG. 1, not shown in FIG. 2) generates a horizontal voltage gradient, and is used to measure the horizontal position of a touch. The top sheet 50 includes a resistive surface 52 on a rectangular portion of the top sheet 50. Although the resistive surface 52 is shaped as a rectangle in this embodiment, many other shapes may be provided for the resistive surface 52, such as a square, or other shapes.

A cable 54 carries electrical signals to the top sheet 50. The cable 54 is electrically connected to a first interconnect 58 and a second interconnect 60 on the top sheet. The interconnects 58, 60 are in turn connected to a first electrode 64 and a second electrode 66, respectively. The electrodes 64, 66 are connected to the top and bottom of the resistive surface 52, respectively. The interconnects 58, 60 are electrically isolated from the resistive surface 52.

The first electrode 64 is located at a top end of the top sheet 50. The first electrode 64 includes a first end 76 near the interconnect 58 and a second end 78 distant from the interconnect 58. The cable and interconnect 58 apply a reference voltage, V_{REF}, to the first electrode 64. The second electrode 66 is located at a bottom end of the top sheet 50. The second electrode 66 includes a first end 86 near the interconnect 60 and a second end 88 distant from the second interconnect 60. A ground voltage, V_{GND}, is applied to the second electrode. Thus, a vertical voltage gradient is formed across the resistive surface 52 ideally ranging from the reference voltage at the top end to the ground voltage at the bottom end.

Similar to the top sheet 50, the bottom substrate 32 shown in FIG. 1 includes a connection to the cable 54 and a first and second interconnect 38, 40 that apply a voltage gradient to the first and second electrodes 44, 46, respectively. The first and second electrodes 44, 46 of the bottom substrate are located on the sides orthogonal to the first and second electrodes 64, 66 of the top sheet 50.

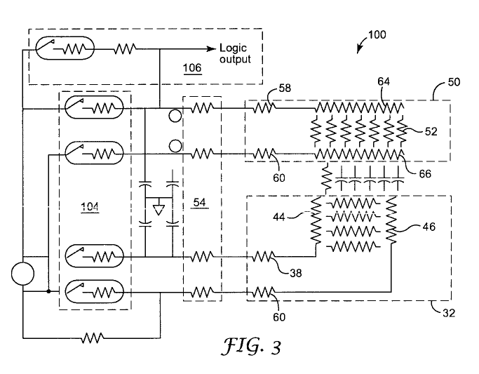

FIG. 3 shows a simplified schematic drawing of a 4-wire touch screen 100 including the top sheet 50 of FIG. 2. Components of the touch screen 100 include the top sheet 50, cable 54, substrate 32, electrode drive switches 104 and a touch down detection circuit 106. The electrode drive switches 104 include drive transistors T_{D1} through T_{D4}, with associated resistances R_{T1} through R_{T4}, that are used to connect a reference voltage to either the top sheet 50 for vertical measurements or to the substrate 32 for horizontal measurements. From the drive transistors 104, current flows through the four portions of the cable 54 with associated cable resistances R_{C1} through R_{C4}. For example, for the top sheet, the current flows from the cable 54 to the first interconnect 58 having associated resistance R_{I1} and then to the first electrode 64 having associated resistance R_{E1}. The current then flows through the resistive surface 52 having a resistance of R_{SV} to the second electrode 66 having associated resistance R_{E2}. The current then flows through interconnect 60 having associated resistance R_{I2} back to the cable.

The substrate 32 is constructed like the topsheet 50 shown in FIG. 2, except the third and fourth electrodes are located on orthogonal opposing edges of the substrate relative to those on the topsheet. For the substrate, the current flows from the cable 54 to third interconnect 38 having associated resistance R_{I3}, and then flows to the third electrode 44 having associated resistance R_{E3}. Current can then flow through the resistive surface of the substrate having a resistance of R_{SH} and then through the fourth electrode 46 having resistance R_{E4}. Current then flows through the fourth interconnect 60 having resistance R_{I4} and back to the cable 54. The top sheet 50 and the substrate 32 establish a distributed intersheet capacitance 140, C_{IS}.

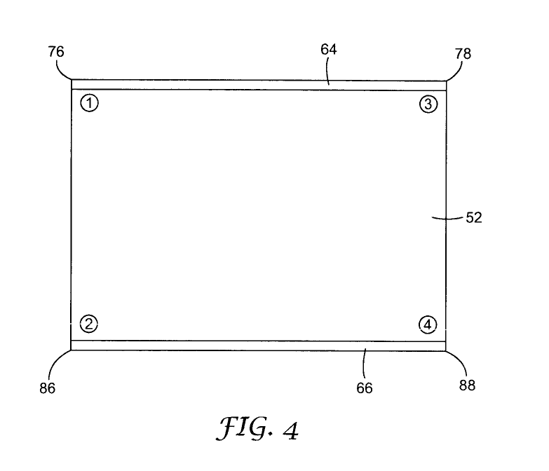

FIG. 4 can be used to discuss how various resistances can affect the voltage gradient, making it deviate from an ideal distribution. In an ideal voltage distribution on a resistive surface 52, when V_{REF} is applied to the first electrode 64 at the top of the sheet and V_{GND} is applied to the second electrode 66 at the bottom of the sheet, the two voltages reach all parts of the respective electrodes without attenuation, for example from end 76 to end 78 of electrode 64, and from end 86 to end 88 of electrode 66. In this situation, a uniform vertical voltage gradient is established across the resistance R_{SV} of the resistive surface 52. Ideally, the voltage distribution across the resistive surface 52 corresponds linearly to the position on the sensor, and the entire applied voltage drop will occur over the surface of the sheet resistor. However, due to finite resistance of the transistors, cables and interconnects, such an ideal voltage distribution does not occur. These finite resistances cause the voltage drop across the sheet resistor to be less than the V_{REF} applied to the transistors. The various deviations from the ideal voltage gradient are referred to as errors, and these errors can result in a touch location being detected inaccurately or incorrectly. Deviations from the ideal voltage gradient can be caused by many factors, discussed in further detail below. Using a higher sheet resistance resistive layer can reduce their effects.

Taking the resistances of other components into account, at the first ends 76 and 86 of the respective electrodes 64 and 66, the voltage is reduced because of the resistances of the transistors, cable and interconnects. As a result, the voltage V₁ at the first end 76 of the first electrode 64 and the voltage V₂ at the first end 86 of the second electrode 66 can be calculated as follows:
V₁=V_{REF}−V_{T}−V_{C}−V_{I}
V₂=V_{GND}+V_{T}+V_{C}+V_{I}
where:
V_{REF}=reference voltage;
V_{GND}=ground voltage;
V_{T}=voltage drop at the transistor;
V_{C}=voltage drop at cable; and
V_{I}=voltage drop at the interconnect.
   In the ideal situation, the voltage differential between point 1 and point 2 (see FIG. 4) is:
   (V₁−V₂)_{ideal}=V_{REF}−V_{GND}.
   When the resistances of the transistors, cable and interconnections are considered, the voltage differential between point 1 and point 2 is:
   (V₁−V₂)ᵣₑₐₗ=V_{REF}−V_{GND}−2V_{T}−2V_{C}−2V_{I}.

The resistances of the transistors, cable and interconnections reduce the voltage differential between the first electrode and second electrode. The range of voltages that will be measured when a touch occurs is restricted, so that the resolution of the system is reduced. This compaction of the range of voltages on the resistive surface is often referred to as a reduction in the dynamic range of the system. Any noise in the voltage measurement will also have a greater impact; the signal-to-noise ratio will be higher when the voltage range is reduced.

The reduced voltage range that occurs can lead to inaccuracies in touch location detection. For example, if a 5 volt applied V_{REF} is reduced to a 4 volt gradient, without calibration, a touch near the edge (yielding a 4 volt signal) will be interpreted as if it had occurred closer to the center than in reality.

Performing calibration operations, such as two, four or five point calibration operations that are known in the art, can compensate for these errors. However, the addition of calibration operation capability increases the complexity and expense of the touch screen system.

Errors can also be increased over the life of the device due to changes to the resistances of the transistors, cable, interconnections and resistive sheet. The resistances of these components can change with time, temperature and humidity. If the resistances of the components change non-uniformly, the voltage gradient becomes non-uniform in proportion to the changes in resistance. These changes may be compensated for by the addition of remote-referenced analog-to-digital converters and low resistance drive transistors, but this adds complexity and cost to the touch screen system.

In addition to the reduction in voltage range due to the cable and interconnects, there is a reduction in voltage across the first electrode and the second electrode, caused by the resistance of each electrode R_{E}. Referring again to FIG. 4, the voltage V₃ at the second end 78 of the first electrode 64 and the voltage V₄ at the second end 88 of the second electrode 66 can be calculated as:
V₃=V_{REF}−V_{T}−V_{C}−V_{I}−V_{E}
V₄=V_{GND}+V_{T}+V_{C}+V_{I}+V_{E}
where V_{E}=voltage drop at an electrode.

The voltage drop across the length of the first and second electrodes causes the resistive surface 52 to carry a non-uniform voltage gradient, resulting in an error often referred to as a trapezoidal or keystone nonlinearity error. As a result, touches to the top sheet may be calculated to be in an erroneous position. A similar keystone error occurs on the substrate. The difference in the voltage between a first end and second end of the two electrodes reduces the dynamic range of measurements made on the sensor, so that the signal to noise ratio and accuracy of the touch panel are reduced, as will be discussed further herein.

Performing a four or five point calibration on the touch screen can compensate for the effects of the keystone errors. However, additional calibration systems add expense to a touch screen system and reduce ease of use. Time, temperature, humidity or other factors may cause a change of sheet resistance or interconnect resistance, which will result in errors that are proportionate to the resistance change in these components. The resulting signal reduction will also result in a lower dynamic range and reduced signal to noise ratio.

Pressures to minimize the size of touch sensor devices will likely increase the importance of the errors caused by the resistances of the electrodes and interconnects. In a resistive touch screen, the interconnects, electrodes, and/or linearization patterns occupy what is referred to as the border area. When a touch sensor is used in connection with an electronic display such as an LCD, the border area of the touch sensor desirably corresponds to the border area of the LCD. Minimization of the border area is desirable to provide more compact display devices. Efforts are continuing at minimizing the border area relative to the frontal area for LCDs. Border areas of touch panels desirably do not exceed the border areas of the display in most applications, so border areas of touch panels are also important to minimize. The width of the electrodes and the interconnections in the border areas are the main contributors to the size of the border area, so narrow electrodes and interconnections are desirable. However, creating narrower electrodes and interconnections may cause higher resistance in those components, resulting in larger errors in the touch panel.

The effect of keystone errors may be reduced by increasing the resistance of the resistive surfaces relative to the resistance of the electrodes. In addition, the effects of errors caused by the resistances of the transistors, cable, and interconnections can be reduced by increasing the resistance of the resistive surface relative to the resistances of the transistors, cable and interconnections. Increasing the sheet resistance is an effective way of making the transistor, electrode and cable resistances small in comparison to the sheet resistance, so effectively all of the voltage drop will occur on the sheet surface, reducing errors. One way to increase the resistance of the resistive surface is to use a conductive polymer instead of one of the TCOs typically used. Conductive polymers can be durable at sheet resistances that are impractical for TCOs.

As used herein, “conductive polymer” refers to polymers that are electrically conductive. Some examples of conductive polymers are polypyrrole, polyaniline, polyacetylene, polythiophene, polyphenylene vinylene, polyphenylene sulfide, poly p-phenylene, polyheterocycle vinylene, and materials disclosed in European Patent Publication EP-1-172-831-A2, which is hereby incorporated by reference herein in its entirety. A preferred substituted polythiophene is poly (3,4-ethylenedioxythiophene) (PEDOT), described in U.S. Pat. No. 5,766,515 and EP-A 686,662, which are both hereby incorporated by reference herein. Preferably, the conductive polymers used in touch screens described herein are intrinsically conductive, meaning that they are conductive without the addition of conductive materials such as carbon, although conductive polymers usually require the addition of a dopant.

The use of a conductive polymer for a resistive surface in a touch screen has many advantages, in addition to the ability to increase the resistance of the resistive surface without compromising physical continuity, uniformity or durability. For example, PEDOT is fairly colorless and environmentally stable. PEDOT can be coated or patterned quickly and easily. Also, PEDOT has better adhesion to organic substrates and overcoats than metal oxides. PEDOT has a much lower refractive index than metal oxides, resulting in lower surface reflections and higher optical transmission. The absorption of PEDOT imparts a slight blue color to a touch screen when it is used, which is preferable to the slight yellow color imparted by ITO. These and other advantages of using conductive polymers in touch screens will be discussed further herein.

Preferably, the resistance element is substantially transparent, i.e. at least about 50% transparent for internal transmission, more preferably at least about 85% transparent, more preferably at least about 90% transparent, and even more preferably at least about 95% transparent. In this document, transparency is discussed in terms of internal transmission, which can be calculated by dividing the intensity of transmitted radiation through a material by the initial intensity minus the reflected intensity, in other words disregarding all interfacial reflections.

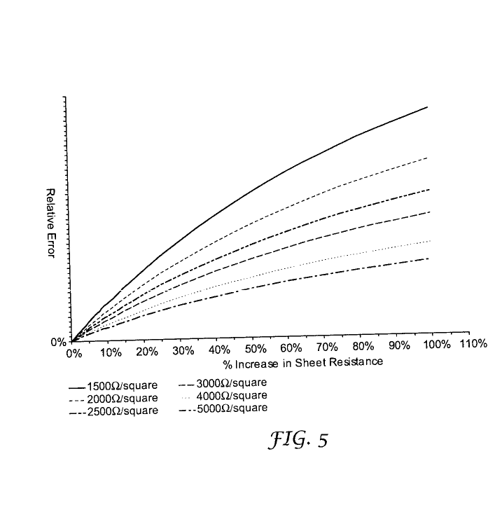

The effect of environmental aging is also reduced by starting with a high sheet resistance. Aging of conducting polymer devices commonly results in an increase of sheet resistance. Increases in sheet resistance without concurrent increase in other system resistance (such as transistor, cable and interconnect resistances) can result in a change in the percentage of the voltage drop which occurs across the transparent conductor, and thus cause detection errors. However, if the sheet resistance is high at the start of the life cycle of a touch device, effectively all of the voltage drop will take place on the transparent conductor, and environmentally-induced sheet resistance increases can only increase this percentage, and thus will not cause significant errors. The effects of increasing sheet resistance on sensor accuracy is a direct function of the starting sheet resistance, as indicated by the graph shown in FIG. 5 reporting results for a 5-wire touch screen. Generally, when sheet resistance of a sensor changes (for example, due to aging effects such as time, temperature, humidity, and the like), there can be a loss of sensor accuracy, and this loss of accuracy is reduced when starting with a higher sheet resistance and comparing against the same percentage change in sheet resistance.

To compare the use of conductive polymer or other high sheet resistance materials with the use of TCOs in touch sensors, it is useful to quantify the errors in a typical touch sensor that uses ITO. Interconnections and electrodes in touch sensors are typically made of conductive ink, printed onto the top sheet 50. The length, width, thickness, and the bulk resistivity of the conductive ink determine the resistance of the interconnections and the electrodes. A typical ink used in forming touch sensors is the ink sold by Emerson Cummings under the trade designation CE3109 and having a typical bulk resistivity of 0.03 ohms/square/mil. Resistance of the ink as printed is about 0.03 ohms/square to 0.05 ohms/square. Calculations reported here are be based on a typical value of about 0.04 ohms/square. The dimensions of the active area or resistive surface 52 of the touch panel determines the length of the interconnections and electrodes.

Typical resistances for components of a touch sensor having a 10.4 inch diagonal measurement (9 inches by 7 inches outer dimensions) are summarized in Table I below. The assumptions underlying these values will now be discussed.

TABLE 1

| | | |
|---|---|---|
| R_{T} | Transistor resistance | 7.0 Ω |
| R_{C} | Cable resistance | 4.8 Ω |
| R_{I} | Interconnect resistance | 1.7 Ω |
| R_{E} | Electrode resistance | 2.3 Ω |
| R_{SH} | Sheet resistance, short | 300 Ω |
| R_{SV} | Sheet resistance, long | 530 Ω |
| R_{Con} | Contact resistance | 220 Ω/500 Ω |
| | | (finger/stylus) |

In such a touch screen, the long side electrodes will be about 8.7 inches by 0.19 inches, resulting in end-to-end resistance of about 2.3 ohm. For a prior art resistive touch screen using ITO as the resistive surface, the inter-electrode resistance of the touch screen in the short dimension is about 300 ohms, or 400 ohms/square sheet resistance multiplied by three-quarter screen aspect ratio, resulting in a voltage loss from end to end for the two electrodes of 0.77% each. This is the keystone error for this type of configuration. For a touch screen made with conducting polymer at 6000 ohm/square, this error would be reduced to about 0.10%.

For a touch screen of 9 inches by 7 inches with a diagonal of 10.4 inches, the interconnections 58, 60 shown in FIG. 2 will be about 3.2 inches each, resulting in an end-to-end resistance of about 1.7 ohms. For a typical prior art ITO touch screen having an inter-electrode resistance of about 300 ohms in the long direction, the voltage loss across each of the two interconnections is about 0.57% for a total signal reduction of about 1.14%, while a touch screen of the present invention having 6000 ohm/square would have only 0.08% error due to interconnects. Performing a 2, 4 or 5 point calibration can compensate for the initial effects of this error.

Cable lengths vary from about 1 inch to over 8 inches. Often, copper flex print cable is used so resistance is negligibly low. Printed cable conductors are much less expensive and may also be used. If a touch screen uses printed conductors of 6 inches by 0.050 inches, the end-to-end resistance is about 4.8 ohm. With a typical ITO resistive touch screen having a long dimension inter-electrode resistance of about 300 ohms, the voltage loss across each of the cable conductors is about 1.6% for a total signal reduction of 3.2%. Again, the initial effects of this error can be compensated by performing a 2, 4 or 5 point calibration.

The drive transistors are typically MOSFET drive transistors and each has a significant resistance. In addition, the resistance of these transistors changes significantly with temperature. For example, the Burr Brown TSC 2003 is a commercially available touch screen controller. Its negative drive transistors have a resistance of 7 ohms in the negative state, varying 18% over a range of 60° C. If such a controller is used with a typical prior art ITO touch screen with a long dimension inter-electrode resistance of about 300 ohm, then voltage loss across each of the two drive transistors is 2.3% for a total reduction of 4.6%, increasing to 5.5% with a 60° C. temperature increase. Performing a 2, 4 or 5 point calibration can compensate for the initial effects of this error, so only the loss of dynamic range (the loss of signal to noise ratio) and temperature effects contribute to errors.

Table 2 below summarizes the effects of using a resistive sheet with a higher sheet resistance of about 6000 ohms/square compared to the use of a lower resistance resistive sheet of 400 ohms/square. Total dynamic range reduction is reduced from 10.5% at 400 ohms/square to 0.72%.

TABLE 2

| | 400 | 6000 |
|---|---|---|
| | ohms/sq. | ohms/sq. |
| Electrode resistance error | 1.52% | 0.10% |
| Sensor interconnect error | 1.14% | 0.08% |
| Cable resistance error | 3.2% | 0.22% |
| Transistor resistance error | 4.6% | 0.32% |
| Total dynamic range reduction | 10.5% | 0.72% |
| Effect of transistor temperature | 0.41% | 0.04% |
| dependence (with 60° C. | | |
| temperature change) | | |

Due to the reduction of these errors, higher sheet resistance can also reduce the need for expensive controller electronics. A higher cost controller with a remote-reference A/D converter (such as the Burr Brown TSC 2003) is commonly used to compensate for the effects of both initial voltage loss and temperature effects. However, with higher sheet resistance, a lower cost controller, for example with typical MOSFET drive transistors, may be used. Table 3 shows the signal-to-noise ratio and accuracy benefits of increased sheet resistance. At the higher sheet resistance, there is essentially no benefit to using the higher cost controller electronics. Error vs. temperature numbers represent changes over a temperature range of 60° C.

TABLE 3
Potential error sources for 4 wire touch
panels of 400 and 6000 ohms/square

| | 400 Ω/square | | 6000 Ω/square | |
|---|---|---|---|---|
| Controller Cost | Lower Cost | Higher Cost | Lower Cost | Higher Cost |
| Electrode | 0.76%/ | 0.76%/ | 0.05%/ | 0.05%/ |
| R error: | 0.07% | 0.07% | 0.003% | 0.003% |
| Initial/Temp | | | | |
| Drive | 0.41% | 0.0% | 0.03% | 0.0 |
| transistor, | | | | |
| error vs. temp | | | | |
| Total signal | 10.5% | 10.5% | 0.72% | 0.72% |
| reduction | | | | |

Reduced power consumption is another advantage of high sheet resistance. During non-touch time, power dissipation in the sensor is negligibly small. However, during the time when the touch sensor is contacted, when voltage gradients are generated across the resistive sheets, power dissipated in the sensor is about V²/R where R is the combination of sheet resistance and contact resistance discussed above, and V is the reference voltage. Gradients are applied with the duty cycle that varies with the desired coordinate rate and noise immunity. An 80% duty cycle is typical for many controllers during a touch. Assuming an 80% duty cycle and V_{Ref}=3V, the sensor powered dissipation shown in Table 4 results from the sensor resistance values shown.

TABLE 4

| | Sensor Power |
|---|---|
| Sensor Resistance R | Dissipation (mWatts) |
| 400 Ω (typical current 3M 4-wire) | 18 |
| 5K | 1.44 |
| 10K | 0.72 |
| 20K | 0.36 |

From an error reduction point of view, the higher the sheet resistance is, the more accurate the touch detection will be. Also, less expensive electronics can be used, and the need for calibration steps and storing calibration data can be reduced. However, there exists an upper limit of sheet resistance for each touch screen based on size, application, and other practical considerations. The upper limit of sheet resistance is determined, at least in part, by the RC time constant of the device, which increases with the sheet resistance and inter-sheet capacitance.

The sampling rate of a touch screen determines how fast sequential touches can be detected, or the time that must elapse before the device can take another measurement. For touch screens used for finger point and touch applications, a rate as low as 30 coordinates per second may be adequate, while for handwriting applications (such as signature capture), it is desirable to have sampling rates as high as 100 or 200 coordinates per second.

Analog data rate limits can be calculated for different resistance values for 4-wire touch sensors, and the results can be used to extrapolate the effect of increased sheet resistance on sampling rate. In calculating these values, analog settling and A/D measurement can be included in the time and coordinate rates. Microprocessor or communication limitations may place an upper limit on the maximum achievable coordinate rate, such that sheet resistances yielding a theoretical coordinate rate approaching or exceeding 300 points per second will likely result in no additional benefit without using a faster microprocessor or communications line.

For calculations, it can be assumed that 5τ is allowed for settling time before measurement while ½τ can be assumed for settling before touchdown confirmation. About 0.5 millisecond can be allowed for each of the X and Y measurements, plus 0.05 millisecond for touchdown confirmation measurement, for a total of 1.05 milliseconds. Total measurement time then includes the following:
Xt=0.5 mSec.+5*R*C_{IS};
Yt=0.5 mSec.+5*R*C_{IS};
TD=0.05 mSec+0.5*(R_{TD}+R)*(C_{IS}+4*C_{f}), where C_{f}=filter capacitors; and
R_{TD}=10KΩ or 2*R, whichever is greater, (to ensure the touchdown voltage divider reaches a voltage that will activate the touchdown comparator).
   The coordinate rate is then given by 1/(Xt+Yt+TD).

For 12 to 15 diagonal inch resistive sensors with air gaps of 12 to 15 microns, C_{IS} is about 50 nF. For 4 to 5 diagonal inch resistive sensors with similar air gaps, C_{IS} is about 6 nF. R can include the sheet resistance as well as the contact resistance from application of the touch implement. A typical contact resistance for a touch applied from a stylus on a resistive touch screen is about 500 ohms.

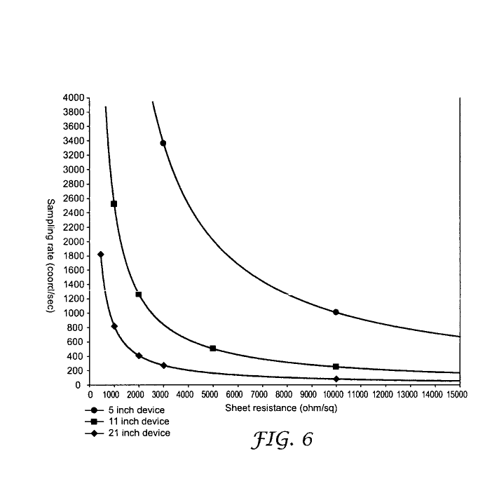

The results shown in FIG. 6 demonstrate the general proposition that, for a touch sensor of a given size, the maximum coordinate sampling rate decreases with increasing sheet resistance of the resistive layer. Maximum coordinate sampling rate also decreases for larger-sized sensors at the same sheet resistance. Therefore, in designing resistive layers for use in touch sensors having a variety of sizes, the size of the largest sensor of interest along with the desired minimum sampling rate can be used to pinpoint, or at least approximate, a maximum sheet resistance of the resistive layer. For example, for sensors up to 21 diagonal inches and sampling rates of at least about 30 coordinates per second, maximum sheet resistance may be about 15,000 ohms/square. As the largest sensor size of interest decreases, higher sheet resistances can be accommodated while achieving the same sampling rate. As the desired sampling rate increases, the maximum sheet resistance decreases for the same size sensor.

Conductive polymers, as well as TCOs, generally have a significant visible absorption when coated thick enough to give low sheet resistance. For touch screens, it is preferable to use conductive polymers at a sheet resistance that gives good transparency. As such, minimum desired internal transmission for the resistive layer can be used to determine a minimum sheet resistance. Together, the optical transmission and the RC constant, which determines the sampling rate can be used to, define an optimum range of sheet resistance for use in touch screens. When coating substrates for conductive polymers, it is preferable to coat a sheet resistance that gives good optical transparency and yet could also be used in any touch screen having a practical resistance to give a sensor with a desirable sampling rate.

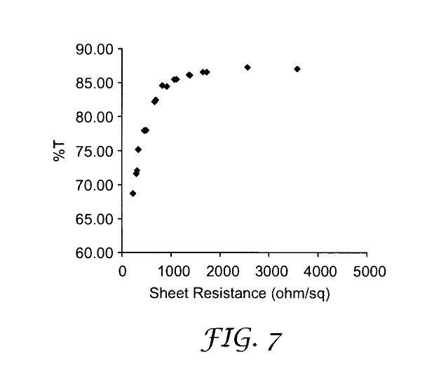

FIG. 7 shows data for the percent transmission of resistive films made by coating PEDOT on glass. From this data it can be seen that a sheet resistance of greater than 1000 ohms/square would be preferable from an optical transmission standpoint gives greater than about 85% internal transmission. Viewing FIGS. 6 and 7 together, it can be determined that sheet resistances up to about 15,000 ohms/square and at least about 1000 ohms/square can give many advantages such as good optical transmission, lower power consumption, and fewer errors due to component resistances, while also allowing sampling rates greater than 30 coordinates per second for sensors up to about 21 diagonal inches.

Given this information regarding optical transmission and sampling rates, a desirable range of sheet resistances can be identified that allows selection of a conductive polymer material and coating thickness to make touch screens for a particular application or range of applications. For example, by selecting the minimum desired sampling rate and the maximum screen size, an RC constant can be determined that identifies the maximum sheet resistance. Minimum sheet resistance is governed at least in part by the desired internal transmission of the resistive material, also noting that higher sheet resistances will result in reduced errors and power consumption. The determined minimum and maximum sheet resistances define an optimum range that can be satisfied by selecting a proper conductive polymer material and coating thickness. This same conductive polymer material and coating thickness can be used for any touch screen that is no bigger than the determined maximum screen size while still satisfying the underlying criteria of sampling rate, etc. As such, a touch sensor having a resistive layer with a sheet resistance in an optimum range can be made by selecting a desired minimum sampling rate, selecting a touch sensor type and maximum dimensions for the touch sensor application(s), determining the RC constant given the selected sampling rate, touch sensor type and dimensions, calculating the maximum sheet resistance from the RC constant, selecting a conductive polymer material, and coating the conductive polymer material on the desired substrate at a thickness and under conditions that give the desired optical properties without exceeding the maximum sheet resistance.

Resistive devices with conducting polymer have been disclosed in U.S. Pat. No. 6,469,267. The examples described therein include only 5-wire constructions where the topsheet includes a conductive polymer and the bottom substrate includes a conventional TCO. Using this construction, the voltage was reduced (preferably to less than 1.0V), and the device was operated with the topsheet at negative polarity with respect to the TCO on the bottom substrate in order to get a usable device. As such, standard industry controller electronics could not be used, requiring a customized, perhaps more expensive controller, all while reducing the signal to noise ratio of the device due to the voltage reduction.

4- and 5-wire resistive touch screens were made by the present inventors and constructed to use a conductive polymer both as the topsheet signal carrying resistive layer and bottom substrate signal carrying resistive layer. The resultant devices showed durability of over 100,000 taps while running at 3 to 5V with standard controllers.

### EXAMPLES

### Comparative Example 1

5-wire resistive touch devices were made with a conducting polymer film as the top resistive layer and a conventional ITO layer as found in standard 5-wire resistive touch screens as the bottom resistive layer. This example demonstrates early failure when ITO and CP are used together at standard operating conditions.

5-wire sensors were fabricated by replacing the standard ITO topsheet of a 5-wire device with a conducting polymer film. The film used was EL1500 (PEDOT on PET, commercially available from Agfa-Gevaert). The sheet resistance of the EL1500 was approximately 1500 ohms/square. The substrate was standard ITO glass with about 400 ohms/square sheet resistance. The sensor size was 4.5 inches by 6 inches.

The sensors were found to accurately detect a touch with the standard MicroTouch 510 controller, commercially available from 3M Touch Systems, Inc., with the controller operating at 5V. A simulated finger tap test was run on the sensors, the test consisting of a silicone probe mounted vertically and pneumatically tapped on the sensor surface. Equipment used included the Data Switch Model 2100 Life Tester with a silicone probe of 45 durometer hardness (ASTM spec #1578). The probe was mounted 0.055 inches above the sensor surface. The test was started with air pressure of 10 psi activating the tapper, which was determined to give a force on the tapper of 62 g. The x-y coordinates were established and viewed on a computer monitor. Failures were determined by a 1% or greater deviation of coordinates or by failure to record a touch. A sensor tested three times in different spots failed after 1289, 952, and 1183 taps.

### Example 2

5-wire devices were made using conducting polymer as both conductive layers. This example demonstrates the improvement in durability obtained by using conducting polymer as both conductive layers.

The experiment described in Comparative Example 1 was repeated, except that the 5-wire devices were fabricated using EL1500 as both the substrate and top conductive layers. The electrodes, interconnects and linearization pattern were screen printed onto the EL1500 using a silver ink available from DuPont under the trade designation 5089. The silver ink was cured at 130° C. for 6 minutes. The sensors were linear and accurate when operated with the 3M Touch Systems, Inc. SMT3 controller. Each of seven 5-wire sensors constructed was tap tested in three positions. The lifetime of the sensors ranged from 128,000 taps to 766,000 taps.

### Example 3

4-wire touch sensors were made with conducting polymer as both conductive layers. This example demonstrates linear 4-wire sensors made with conducting polymer.

3 inch by 3 inch 4-wire touch sensors were fabricated by printing the DuPont 5089 silver ink onto EL1500 and curing as described in Example 2. Devices were assembled with the conductive sides facing but separated by a 0.003 inch thick frame of double sided tape positioned around the perimeter, which functioned as a spacer. A small piece of conductive tape available from Chromerics was attached to each of the four silver electrodes, and a wire was soldered onto each electrode using this tape and connected to the 3M Touch Systems, Inc. SC4 controller. The sensors functioned well, accurately detecting the location of touches and linear lines were drawn.

A stylus rub durability test was run on several sensors that were constructed according to this Example 3. A 0.8 mm radius PDA-type stylus weighted to apply 250 g was rubbed in a linear 0.75 inch back and forth cycle at 54 cycles/minute. The line detected by the sensor was viewed on a computer monitor with 640 by 480 pixel resolution, and failure was determined by a break in the line or a 7 pixel deviation from linearity. The EL1500 4-wire sensors so made and tested were found to give an average of 27,000 strokes before failure.

### Example 4

Contrast ratio of PEDOT was compared to that of ITO. This example illustrates the optical advantages of conducting polymer compared to ITO.

Conducting polymer films having a range of sheet resistances were obtained from Agfa-Gavaert Corp. Contrast ratio, defined as total transmission divided by total reflectance, along with color shift of the films were compared to standard ITO. The PEDOT material, with much lower reflectance, gave a much higher contrast ratio than ITO. In addition, the PEDOT provided a blue color shift, which is much preferred for a display over the yellow shift given by ITO.

### Example 5

8-wire touch screen using conductive polymer. This example demonstrates linear 8-wire sensors made with conducting polymer.

Sensors were fabricated from EL1500 film as in Example 3, except that an 8-wire design was printed with the silver ink instead of the 4-wire pattern. This 8-wire design contains an extra connection to each Ag electrode. The device was operated with a testing program and a 3M MicroTouch SC4 controller, which can operate both 4-wire and 8-wire sensors. A straight line drawn through the center of the sensor was detected as such, showing that the sensor was linear. The sensor was aged at 60° C. and 90% relative humidity for 10 days, after which it was still linear.

The above specification, examples and data provide a complete description of the manufacture and use of the composition of the invention. Since many embodiments of the invention can be made without departing from the spirit and scope of the invention, the invention resides in the claims hereinafter appended.

1. A resistive touch screen transmissive of visible light comprising:
a top sheet movable toward a bottom substrate under the influence of a touch input, the top sheet comprising a first conductive polymer layer facing a second conductive polymer layer disposed on the bottom substrate, the touch screen configured for electronic coupling to controller electronics that use signals generated when the first and second conductive polymer layers make local contact to determine the position of local contact.

2. The resistive touch screen of claim 1, wherein the first conductive polymer layer has a sheet resistance of 1000 ohms per square or greater.

3. The resistive touch screen of claim 1, wherein the first conductive polymer layer has a sheet resistance in the range of 1000 ohms per square to 15,000 ohms per square, inclusive.

4. The resistive touch screen of claim 1, wherein the second conductive polymer layer has a sheet resistance of 1000 ohms per square or greater.

5. The resistive touch screen of claim 1, wherein the second conductive polymer layer has a sheet resistance in the range of 1000 ohms per square to 15,000 ohms per square, inclusive.

6. The resistive touch screen of claim 1, wherein the conductive polymer layers have sizes and sheet resistances that allow a data sampling rate of at least 30 coordinates per second.

7. The resistive touch screen of claim 1, wherein the conductive polymer layers have sizes and sheet resistances that allow a data sampling rate of at least 100 coordinates per second.

8. The resistive touch screen of claim 1, wherein the internal transmission of the conductive polymer layers taken together is 85% or greater.

9. The resistive touch screen of claim 1, wherein the first conductive polymer is biased positively relative to the second conductive polymer layer.

10. The resistive touch screen of claim 1 configured to operate using controller electronics that apply 3 to 5 volts across one or both of the conductive polymer layers.

11. The resistive touch screen of claim 1 having a 4-wire construction.

12. The resistive touch screen of claim 1 having a 5-wire construction.

13. The resistive touch screen of claim 1 having a 7-wire construction.

14. The resistive touch screen of claim 1 having an 8-wire construction.

15. A resistive touch screen system comprising:
a top sheet movable toward a bottom substrate under the influence of a touch input, the top sheet comprising a first resistive layer facing a second resistive layer disposed on the bottom substrate, at least one of the first and second resistive layers comprising a conductive polymer; and
controller electronics electronically coupled to the first and second resistive layers, the controller electronics configured to use signals generated when the first and second resistive layers make local contact to determine the position of local contact,
wherein the touch screen systems yields 100,000 or more touch inputs in the same location before failure of the device when the controller electronics are operated at about 3 to 5 volts.

16. The resistive touch screen system of claim 15, wherein both the first and second resistive layers comprise conductive polymers.

17. A method of making a touch sensor comprising a resistive layer disposed on a substrate comprising:
selecting a desired minimum sampling rate for the touch sensor;
selecting a touch sensor construction and dimensions for the resistive layer;
determining the RC constant of the resistive layer given the selected dimensions;
determining a maximum sheet resistance for the resistive layer based on the determined RC constant; and
coating a conductive polymer material on the substrate to form the resistive layer at a thickness that gives a sheet resistance that does not exceed the maximum sheet resistance.

18. The method of claim 17, wherein the conductive polymer material is coated at a thickness that gives an internal transmission of 85% or greater.
